(19) United States
(12) Patent Application Publication
(10) Pub. No.: US 2025/0156949 A1
(43) Pub. Date: May 15, 2025

(54) FOREIGN EXCHANGE HEDGING SYSTEM

(71) Applicant: WINSIDE Co.,Ltd, Osaka Shi Higashinari Ku (JP)

(72) Inventor: Kenji NAKAJIMA, Osaka Shi Higashinari Ku (JP)

(21) Appl. No.: 18/918,049

(22) Filed: Oct. 17, 2024

(30) Foreign Application Priority Data
Nov. 10, 2023 (JP) 2023-192021

(51) Int. Cl. G06Q 40/04

(52) U.S. Cl. CPC G06Q 40/04

(57) ABSTRACT

A foreign exchange hedging system for using a predetermined asset to automatically buy and sell another asset based on a real-time chart that displays in real time a change in a rate for exchanging the predetermined asset for the other asset, the foreign exchange hedging system comprising: a buying processor that carries out a transaction to buy a predetermined number of other assets based on a buying threshold for buying the other asset on the real-time chart; a selling processor that carries out a transaction to sell a predetermined number of the other assets based on a selling threshold for selling the other asset on the real-time chart; and a profit locking-in processor that locks in a profit by selling all of the other asset owned, on the basis of a profit lock-in threshold for a transaction on the real-time chart to obtain a predetermined asset.

### CROSS-REFERENCE TO RELATED APPLICATIONS

This patent specification is based on Japanese patent application, No. 2023-192021 filed on Nov. 10, 2023 in the Japan Patent Office, the entire contents of which are incorporated by reference herein.

### TECHNICAL FIELD

The present invention relates to foreign exchange hedging systems.

### BACKGROUND OF THE INVENTION

Traditionally, foreign exchange transactions have involved transactions such as the exchange of US dollars for Japanese yen or US dollars for gold. As technology related to the present invention, for example, Patent Document 1 discloses a foreign exchange trading program including: a real-rate gadget that displays in real time currency pairs, selling and buying prices, etc. for foreign exchange transactions on the desktop screen of a terminal connected to the Internet; a calculation/order gadget that displays an order button, and input windows for inputting a currency pair, start date, close date, etc., and uses the input data to simulate and present a predicted amount acquired; and a trading interface that when the order button is clicked, displays an order screen for causing a foreign exchange trading system to execute a foreign exchange transaction procedure and instructs the foreign exchange trading system to execute the foreign exchange transaction procedure.

### PRIOR ART DOCUMENT

### Patent Documents

[Patent Document 1] JP 2010-152801 A

### SUMMARY OF THE INVENTION

It is not easy for amateurs to profit from foreign exchange transactions. Therefore, amateurs who take the easy way out in foreign exchange transactions may suffer enormous losses.

The present invention is directed to providing a foreign exchange hedging system that enables even an amateur to stably make a profit.

A foreign exchange hedging system according to the present invention is a foreign exchange hedging system for using a predetermined asset to automatically buy and sell another asset based on a real-time chart that displays in real time a change in a rate for exchanging the predetermined asset for the other asset, the foreign exchange hedging system comprising: a buying processor that carries out a transaction to buy a predetermined number of the other assets based on a buying threshold for buying the other asset on the real-time chart; a selling processor that carries out a transaction to sell a predetermined number of the other assets based on a selling threshold for selling the other asset on the real-time chart; and a profit locking-in processor that executes an order by the buying processor and the selling processor based on a profit lock-in threshold for a transaction on the real-time chart to lock in a profit; wherein on the real-time chart, an initial buy order or sell order is placed on a market basis, the buying processor, when the initial order is a buy order, determines a rate at the buy order as the buying threshold, and determines the buying threshold−a first predetermined value as the selling threshold, the selling processor, when the initial order is a sell order, determines a rate at the sell order as the selling threshold, and determines the selling threshold+a first predetermined value as the buying threshold, the buying processor and the selling processor carry out second-time and onward transactions with the buying threshold and the selling threshold determined in the initial order fixed at a constant value, and in the second-time and onward transactions, place a buy order or sell order so as to carry out a transaction opposite from a previous transaction when the buying threshold or the selling threshold is exceeded, an order quantity in second-time and onward orders being set to be greater than or equal to an order quantity in a previous order, and the profit locking-in processor locks in a profit over the profit lock-in threshold determined by the buying threshold+a second predetermined value in the real-time chart, or under the profit lock-in threshold determined by the selling threshold−a second predetermined value.

Also, in the foreign exchange hedging system according to the present invention, it is preferable that a second adjustment processor that stops a new transaction for buying or selling the other asset when the number of buying or selling the other asset exceeds a predetermined number, and sets the second predetermined value to a smaller value be provided.

With the present invention, even amateurs can make stable profits.

### BRIEF DESCRIPTION OF DRAWINGS

FIG. 1 is a diagram representing a foreign exchange hedging system of an embodiment involving the present invention.

FIGS. 2A and 2B show diagrams representing transactions of gold trading in the foreign exchange hedging system of the embodiment involving the present invention.

FIGS. 3A and 3B show diagrams representing, in the foreign exchange hedging system of the embodiment involving the present invention, changes in transactions of gold trading due to the introduction of gap down and profit down.

FIG. 4 is a diagram representing, in the foreign exchange hedging system of the embodiment involving the present invention, gold trading with gap down and profit down being introduced, and is a diagram representing transactions in which profits have been locked in on selling.

FIG. 5 is a diagram representing, in the foreign exchange hedging system of the embodiment involving the present invention, gold trading with gap down and profit down being introduced, and is a diagram representing transactions in which profits have been locked in on buying.

FIG. 6 is a diagram representing, in the foreign exchange hedging system of the embodiment involving the present invention, transactions of gold trading with a cut loss (cut-loss position and cut-loss profit) being introduced.

### DETAILED DESCRIPTION OF THE INVENTION

Hereinafter, a mode of embodying the present invention is explained in detail with reference to the accompanying drawings. In the following, like elements are assigned the same reference numerals in all the figures in the drawings, and a repeated description is omitted. In addition, in the description in the text, the reference numerals mentioned previously are used if necessary.

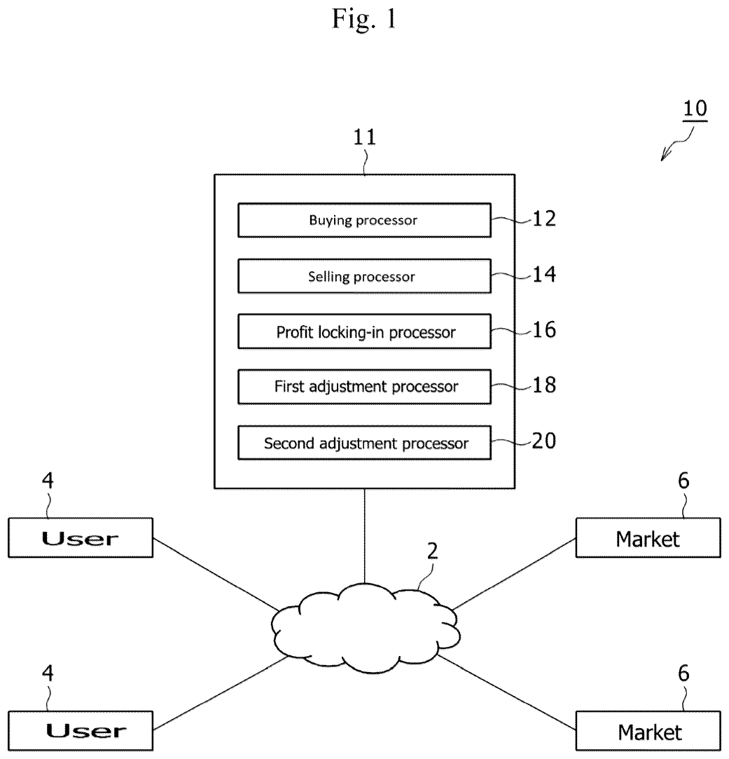

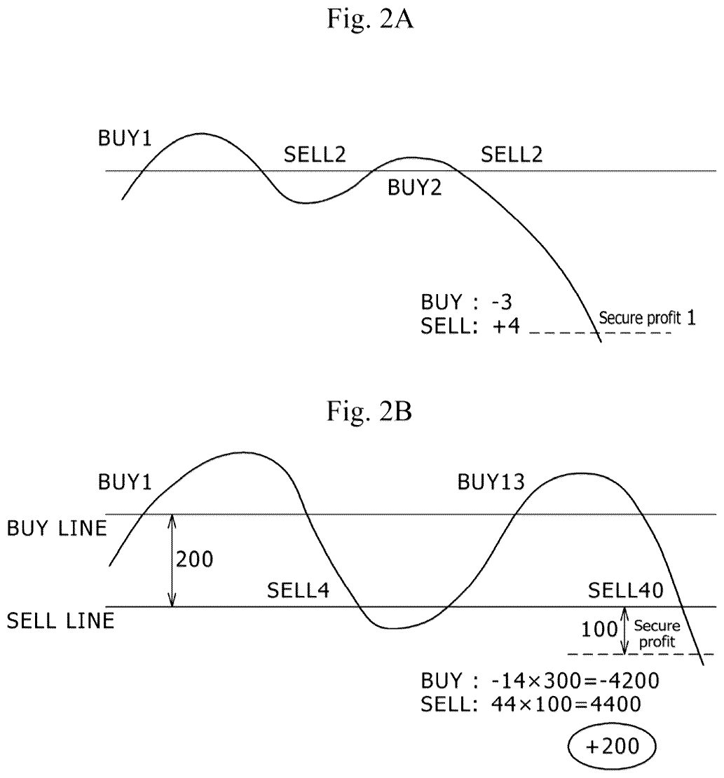

FIG. 1 is a diagram representing a foreign exchange hedging system 10 of an embodiment involving the present invention. FIGS. 2A and 2B are diagrams representing transactions of gold trading in the foreign exchange hedging system 10 of the embodiment involving the present invention.

FIG. 2A is a diagram representing, in the foreign exchange hedging system 10 of the embodiment involving the present invention, transactions conducted with a buying threshold and a selling threshold being the same, and FIG. 2B is a diagram representing transactions conducted with a gap between a buying threshold and a selling threshold.

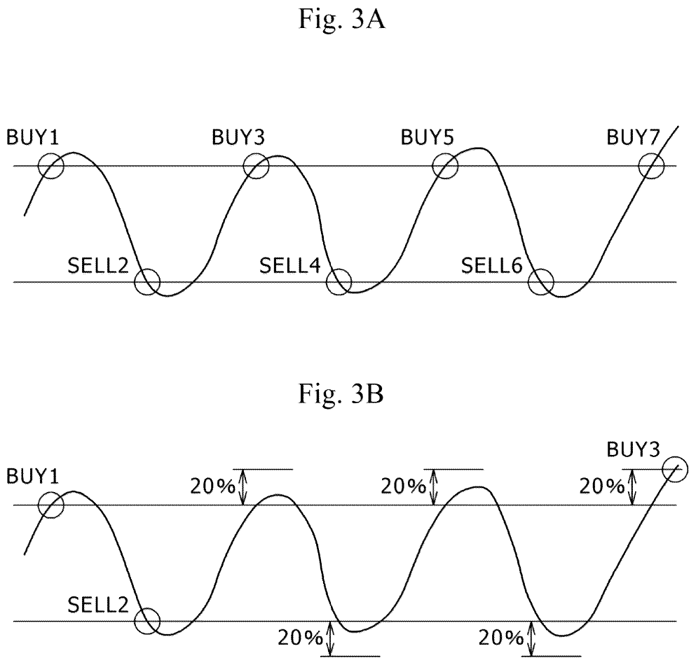

FIGS. 3A and 3B show diagrams representing, in the foreign exchange hedging system 10 of the embodiment involving the present invention, changes in transactions of gold trading due to the introduction of a gap down.

FIG. 3A is a diagram representing transactions conducted with a gap (gap down being absent) between a buying threshold and a selling threshold, and FIG. 3B is a diagram representing transactions conducted with a gap (gap down being present) between a buying threshold and a selling threshold.

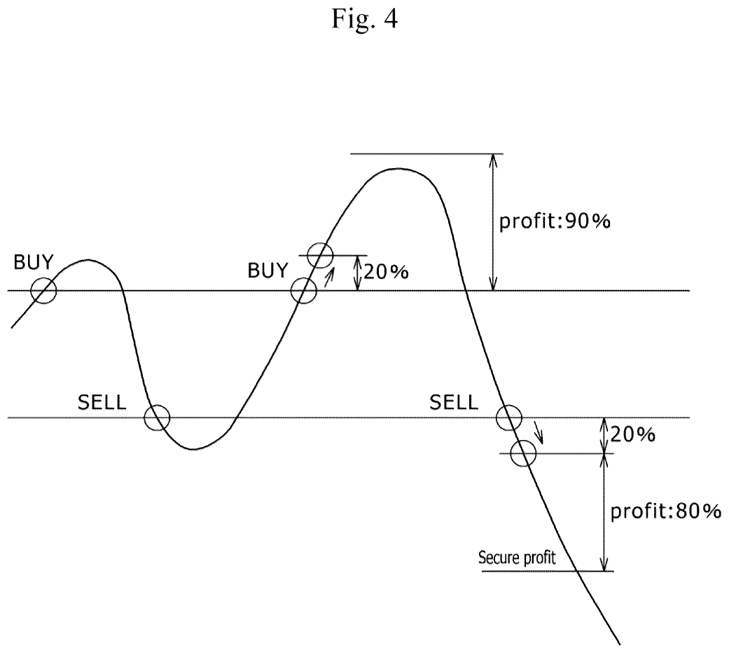

FIG. 4 is a diagram representing, in the foreign exchange hedging system 10 of the embodiment involving the present invention, gold trading with gap down and profit down being introduced, and is a diagram representing transactions in which profits have been locked in on selling.

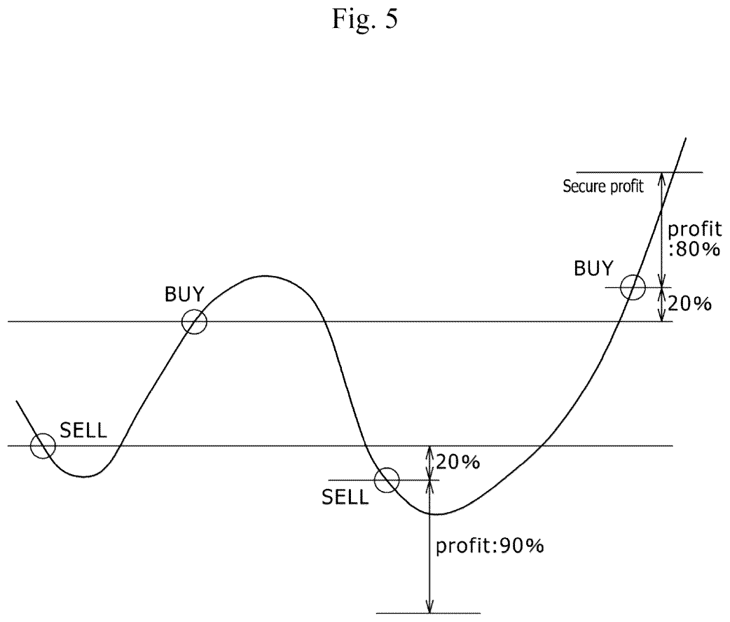

FIG. 5 is a diagram representing, in the foreign exchange hedging system 10 of the embodiment involving the present invention, gold trading with gap down and profit down being introduced, and is a diagram representing transactions in which profits have been locked in on buying.

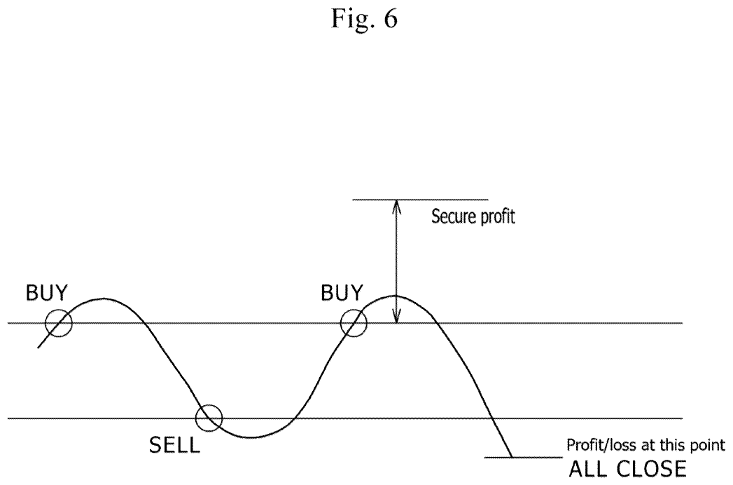

FIG. 6 is a diagram representing, in the foreign exchange hedging system 10 of the embodiment involving the present invention, transactions of gold trading with a cut loss (cut-loss position and cut-loss profit) being introduced.

The foreign exchange hedging system 10 is a system that on the basis of a real-time chart that displays in real time changes in the rate for exchanging a predetermined asset for another asset, uses the predetermined asset to automatically buy and sell the other asset.

The foreign exchange hedging system 10 is provided with a server 11 having a buying processor 12; a selling processor 14; a profit locking-in processor 16; a first adjustment processor 18; and a second adjustment processor 20.

The foreign exchange hedging system 10 is connected to the terminals of users 4 and markets 6 via a network 2. The markets 6 are securities companies or other institutions that deal in foreign currencies or the like.

The network 2 is a communications network capable of two-way communications, a typical example of which is the Internet. The terminals of the users 4 may be any device that can be connected to the network 2, such as a personal computer that can be connected to the Internet, or a mobile terminal such as a mobile phone.

When an oversold or overbought position traded in foreign-exchange margin trading is established, the server 11 functions to determine that it is time to buy or sell when a foreign exchange loss reaches a certain range in price, and to automatically settle the position.

The server 11 transmits and receives to and from the terminals of the users 4 via the network 2 data on new orders for trading objects and deposit settings for the new orders.

The server 11 imports the transmitted and received data on the new orders and the deposit settings for the new orders, sets a deposit required per trading currency unit for the new orders in foreign-exchange margin trading, places the new orders for trading objects, obtains current foreign exchange rate information (real-time chart) from outside, and establishes and automatically settles an oversold or overbought position in the above-mentioned foreign-exchange margin trading.

The server 11 is connected to a foreign exchange rate providing system owned by the markets 6. This foreign exchange rate providing system sends current foreign exchange rate information (real-time chart) from outside to the server 11; it is adapted to receive and send foreign exchange rate information provided by banks (markets 6) that handle foreign exchange transactions.

The buying processor 12 and the selling processor 14 set a deposit required per trading currency unit for the new orders in foreign-exchange margin trading, and have storage means (e.g., memory) in and from which data can be written and read. They are adapted to set and store a deposit required per 100,000 US dollars, for example, inputted via the network 2 from the terminals of the users 4 being 400,000 yen, for example. Then, the buying processor 12 and the selling processor 14 calculate the quantity of the position bought and sold from the funds and margin by means of the gap and the profit.

The buying processor 12 and the selling processor 14 set methods for buying and selling orders for trading objects in foreign-exchange margin trading, places new orders, and have storage means (e.g., memory) in and from which data can be written and read.

They are adapted to store conditions, such as the type of asset to be bought and sold (e.g., gold/US dollar, US dollar/yen, pound/yen, euro/yen, Australian dollar/yen, etc.), transaction amount, and designated price, which are inputted via the network 2 from the terminals of the users 4.

The buying processor 12, the selling processor 14, and the profit locking-in processor 16 obtain the current foreign exchange rate information from outside, and have a receiving means, for example. They are adapted to receive exchange rate information (real-time chart) of, for example, gold/US dollar sent from a foreign exchange rate providing system owned by the markets 6.

The profit locking-in processor 16 compares the obtained current foreign exchange rate with a threshold and executes an order, and has a comparison means, for example.

The buying processor 12 carries out a transaction to buy a predetermined number of other assets on the basis of a buying threshold for buying other assets on the real-time chart. Specifically, as illustrated in FIG. 2A, the buying processor 12 places an initial buy order (to buy gold with US dollars) on a market basis, and the rate at this time serves as the buying threshold and the selling threshold.

The selling processor 14 carries out a transaction to sell a predetermined number of other assets on the basis of a selling threshold for selling other assets on the real-time chart. Specifically, as illustrated in FIG. 2A, after the buying processor 12 has placed the initial buy order on a market basis, when the rate reaches the selling threshold as determined at this time, the selling processor 14 places a sell order (to sell gold to obtain US dollars).

The profit determination processor 16 executes the orders by the buying processor 12 and the selling processor 14 to lock in profit, on the basis of a profit lock-in threshold for transactions on the real-time chart. Specifically, as illustrated in FIG. 2A, buying and selling are executed every time the real-time chart exceeds the buying threshold and the selling threshold, and when it exceeds the profit lock-in threshold provided with a predetermined gap from the buying threshold and the selling threshold, orders by the buying processor 12 and the selling processor 14 are executed so that profits be locked in.

The operation of the foreign exchange hedging system 10 having the above configuration will now be described. As illustrated in FIG. 2A, in the real-time chart for exchanging US dollars with gold, the buying processor 12 places a first-time buy order on a market basis.

The rate at the first-time buy order (BUY) is determined as the buying threshold and the selling threshold, and the order quantity at the first-time buy order is set to one time. Then, as illustrated in FIG. 2A, the chart depicts a curve going up and down like a parabola, and when the price falls below the buying threshold and the selling threshold, the first-time sell order (SELL) is placed. At this time, the order quantity to sell is two times that at the first-time buy order.

The chart then depicts a curve like a downward parabola that rises again, and when the price exceeds the buying threshold and the selling threshold, a second-time buy order is placed. At this time, the order quantity to buy is purchase two times that at the first-time buy order.

The chart then depicts a curve going up and down like a parabola again, and when the price falls below the buying threshold and the selling threshold, a second-time sell order (SELL) is placed. At this time, the order quantity to sell is two times that at the first-time buy order.

After this, as illustrated in FIG. 2A, the real-time chart continuously depicts fall, and when the price falls below the profit lock-in threshold, which is provided with a predetermined gap value from the buying threshold and the selling threshold, the orders having been placed up to that point are executed to lock in profits. At this time, since the buy order (BUY) is −3 and the sell order (SELL) is +4, profits of one time can be gained.

As described above, the foreign exchange hedging system 10 has the remarkable effect of enabling the user 4 to make stable profits through automatic buying and selling without the need for making transactions by themselves while checking real-time charts.

In FIG. 2A, the buying threshold and the selling threshold are set to the same value, whereas in FIG. 2B, a difference (gap) of a first predetermined value is set between the buying threshold and the selling threshold. At this time, the profit lock-in threshold is set with differences (profit) of a second predetermined value each from the buying threshold and from the selling threshold. The reason for providing a gap is that it is preferable that a certain gap be present in consideration of the spread and the stop level.

As illustrated in FIG. 2B, in the real-time chart for exchanging US dollars with gold, the buying processor 12 places a first-time buy order (BUY) on a market basis.

The rate at the first-time buy order (BUY) is determined as the buying threshold and the order quantity at the first-time buy order is set to one time, and with a difference (gap) of the first predetermined value being set to 200, the selling threshold is determined.

Then, as illustrated in FIG. 2B, the chart depicts a curve going up and down like a parabola, and when the price falls below the selling threshold, the first-time sell order (SELL) is placed. At this time, the order quantity to sell is four times that at the first-time buy order.

The chart then depicts a curve like a downward parabola that rises again, and when the price exceeds the buying threshold, a second-time buy order is placed. At this time, the order quantity to buy is purchase thirteen times that at the first-time buy order.

The chart then depicts a curve going up and down like a parabola again, and when the price falls below the selling threshold, a second-time sell order (SELL) is placed. At this time, the order quantity to sell is forty times that at the first-time buy order.

After this, as illustrated in FIG. 2B, the real-time chart continuously depicts fall, and when the price falls below the profit lock-in threshold, which is provided with a predetermined profit value (here, 100) to the selling threshold, the orders having been placed up to that point are executed to lock in profits. At this time, since the buy order (BUY) is −14×300=−4200 and the sell order (SELL) is 44×100=4400, profits of +200 can be gained.

Next, as illustrated in FIGS. 3A and 3B, an example of introducing a gap down that widens a gap when the number of buys and sells increases is described. FIG. 3A is a diagram representing transactions conducted with a constant gap as illustrated in FIG. 2B without a gap down for comparison, and FIG. 3B is a diagram representing diagram representing transactions conducted with a 20% gap down introduced. In a situation where gap down is not provided, as illustrated in FIG. 3A, there is a possibility that many positions will be taken, and therefore, in order to reduce the risk of losing margin, the number of positions is limited.

The gap-down settings are carried out by the function of the first adjustment processor 18. The first adjustment processor 18 has a function of setting a value (gap) of the first predetermined value to be larger as the number of buying or selling other assets increases.

FIG. 4 is a diagram representing transactions in which a 20% gap down is introduced and profits are locked in with a sell order (SELL). As illustrated in FIG. 4, compared to the first-time buy order (BUY) and sell order (SELL), the difference (gap) of the first predetermined value at the second-time buy order (BUY) onward is 20% reduced in carrying out transactions, with the difference (profit) of the second predetermined value at this time being set to 90%, and here, profits are locked in after the second-time sell order.

FIG. 5 is a diagram representing transactions in which a 20% gap down is introduced and profits are locked in with a buy order (BUY). As illustrated in FIG. 5, compared to the first-time sell order (SELL) and buy order (BUY), the difference (gap) of the first predetermined value at the second-time buy order (BUY) onward is 20% reduced in carrying out transactions, with the difference (profit) of the second predetermined value at this time being set to 90%, and here, profits are locked in after the second-time buy order. It should be noted that in FIGS. 4 and 5, 10 profit down and the down start position are set at the third position, but this is not limited to the third position and may be at other positions such as the fourth position or the fifth position.

FIG. 6 is diagram representing transactions in which a cut loss is set. The cut loss includes a cut-loss position and a cut-loss profit. The cut loss is set by the function of the second adjustment processor 20. The second adjustment processor 20 stops new transactions for buying or selling another asset when the number of buying or selling other assets exceeds a predetermined number, and sets the second predetermined value to a smaller value.

Here, a sell order (SELL) or a buy order (BUY) is set as one position. Here, the second adjustment processor 20 stops a new order with a maximum of three positions.

### DESCRIPTION OF THE REFERENCE NUMERALS

2: Network, 4: User, 6: Exchange, 10; Foreign exchange hedging system, 11: Server, 12; Buying processor 14: Selling processor, 16: Profit locking-in processor, 18 First adjustment processor, 20: Second adjustment processor

1. A foreign exchange hedging system for using a predetermined asset to automatically buy and sell another asset based on a real-time chart that displays in real time a change in a rate for exchanging the predetermined asset for the other asset, the foreign exchange hedging system comprising:
a buying processor that carries out a transaction to buy a predetermined number of the other assets based on a buying threshold for buying the other asset on the real-time chart;
a selling processor that carries out a transaction to sell a predetermined number of the other assets based on a selling threshold for selling the other asset on the real-time chart; and
a profit locking-in processor that executes an order by the buying processor and the selling processor based on a profit lock-in threshold for a transaction on the real-time chart to lock in a profit; wherein
on the real-time chart, an initial buy order or sell order is placed on a market basis,
the buying processor, when the initial order is a buy order, determines a rate at the buy order as the buying threshold, and determines the buying threshold−a first predetermined value as the selling threshold,
the selling processor, when the initial order is a sell order, determines a rate at the sell order as the selling threshold, and determines the selling threshold+a first predetermined value as the buying threshold,
the buying processor and the selling processor carry out second-time and onward transactions with the buying threshold and the selling threshold determined in the initial order fixed at a constant value, and in the second-time and onward transactions, place a buy order or a sell order so as to carry out a transaction opposite from a previous transaction when the buying threshold or the selling threshold is exceeded, an order quantity in second-time and onward orders being set to be greater than or equal to an order quantity in a previous order, and
the profit locking-in processor locks in a profit over the profit lock-in threshold determined by the buying threshold+a second predetermined value in the real-time chart, or under the profit lock-in threshold determined by the selling threshold−a second predetermined value.

2. The foreign exchange hedging system according to claim 1, further comprising:
a second adjustment processor that stops a new transaction for buying or selling the other asset when the number of buying or selling the other asset exceeds a predetermined number, and sets the second predetermined value to a smaller value.
